(19) United States
(12) Patent Application Publication
(10) Pub. No.: US 2025/0361409 A1
(43) Pub. Date: Nov. 27, 2025

(54) TOP-COAT MATERIAL COMPOSITION FOR USE IN CONSTRUCTION

(71) Applicant: ONX, INC., Carrollton, TX (US)

(72) Inventor: Mohamed Kassim Jahaber, George Town (MY)

(21) Appl. No.: 18/674,502

(22) Filed: May 24, 2024

(51) Int. Cl. C09D 7/20; C04B 41/00; C04B 41/45; C04B 41/48; C04B 41/63; C09D 133/04

(52) U.S. Cl. CPC C09D 7/20; C04B 41/009; C04B 41/4535; C04B 41/483; C04B 41/63; C09D 133/04

(57) ABSTRACT

A top-coat material composition for a bio-cement tile for use in construction includes acrylic resin and a plurality of solvents. The plurality of solvents includes xylene, naphtha, trimethylbenzene, and ethylbenzene. A top-coat material when applied on a surface of the bio-cement tile penetrates the surface and fills voids within the bio-cement tile to form a chemical, water, and stain resistant coat over the surface of the bio-cement tile. Further, a method of using top-coat material composition in a construction activity includes obtaining the top-coat material composition, the top-coat material composition including acrylic resin, xylene, naphtha, trimethylbenzene, and ethylbenzene. The method further includes applying the top-coat material composition on the surface of a bio-cement tile.

### FIELD OF THE INVENTION

The present disclosure generally relates to coating material compositions formulated for architectural applications as well as methods of using these compositions in construction related activities. In particular, the present disclosure relates to a top-coat material composition that when applied on surfaces of bio-cement tiles, forms a top-coat with high chemical, water, and stain resistance.

### BACKGROUND OF THE INVENTION

Builders of both commercial and non-commercial buildings are constantly looking for new innovative products to make buildings more environment friendly and energy efficient, to better protect them from the weather, and to make them more aesthetically pleasing, among other like objects.

Due to rapid concretization, the demand for cement and concrete is continually growing and so is the surge in the global carbon dioxide emissions. Therefore, it is becoming more imperative than ever to invest in technology that eliminates the climate impact of various construction processes. Bio-cement technology is one such technology that is revolutionizing the construction industry and is replacing Ordinary Portland cement (OPC) tiles with bio-cement tiles. Bio-cement technology harnesses the power of biological enzymatic processes from microorganisms to grow durable cement from which bio-cement tiles are manufactured.

Once the bio-cement tiles are set, there is required a top-coat material on the surface of the bio-cement tiles. Currently, the top-coat materials that are being used for bio-cement tiles are not exhibiting satisfactory performance. Such top-coat materials are not durable, hence require more frequent coating. Further, such top-coat materials are neither chemical resistant nor stain resistant. Also, high water permeability hinders the performance of the top-coat materials.

Therefore, new and improved top-coat compositions are needed for use in construction related activities. The present disclosure provides such compositions as well as methods of making and using these compositions in construction activities.

### SUMMARY OF THE INVENTION

Embodiments of top-coat material compositions and methods for manufacturing and using them in construction to address at least some of the above challenges and issues are disclosed.

In some aspects, the present disclosure is directed to a top-coat material composition for bio-cement tiles for use in construction. The top-coat material composition includes acrylic resin and a plurality of solvents. The plurality of solvents comprises xylene, naphtha, trimethylbenzene, and ethylbenzene. A top-coat material when applied on a surface of the bio-cement tile penetrates the surface and fills voids within the bio-cement tile to form a chemical, water, and stain resistant coat over the surface of the bio-cement tile.

In some embodiments, a quantity of the acrylic resin is between 20-30% by weight of the top-coat material composition, a quantity of the xylene is between 15-25% by weight of the top-coat material composition, a quantity of the naphtha is between 30-55% by weight of the top-coat material composition, a quantity of the trimethylbenzene is between 10-20% by weight of the top-coat material composition, and a quantity of the ethylbenzene is 5-10% by weight of the top-coat material composition.

In some embodiments, the top-coat material applied on the surface of the bio-cement tile reduces water permeability of the bio-cement tile.

In some embodiments, the top-coat material composition applied on the surface of the bio-cement tile is colorless.

In some embodiments, the top-coat material composition excludes a requirement of ultraviolet (UV)-curing.

In some aspects, the present disclosure is directed to a method of using a top-coat material composition in a construction related activity. The method includes obtaining the top-coat material composition that comprises acrylic resin, xylene, naphtha, trimethylbenzene, and ethylbenzene. The method further includes applying the top-coat material composition on the surface of a bio-cement tile. The top-coat material composition penetrates the surface and fills voids within the bio-cement tile to form a chemical, water, and stain resistant coat over the surface of the bio-cement tile.

### BRIEF DESCRIPTION OF THE DRAWINGS

Further advantages of the disclosure will become apparent by reference to the detailed description of preferred embodiments when considered in conjunction with the drawings. In the drawings, identical numbers refer to the same or a similar element.

FIG. 1 illustrates ingredients collated in the form of a group that make up an exemplary top-coat material composition, in accordance with some embodiments of the present disclosure.

FIG. 2 illustrates an arrangement for preparing top-coat material compositions, in accordance with some embodiments of the present disclosure.

FIG. 3 illustrates the steps of a method for using top-coat material compositions for construction activities, in accordance with some embodiments of the present disclosure.

### DETAILED DESCRIPTION

The following detailed description is presented to enable any person skilled in the art to make and use the disclosure. For purposes of explanation, specific details are set forth to provide a thorough understanding of the present disclosure. However, it will be apparent to one skilled in the art that these specific details are not required to practice the disclosure. Descriptions of specific applications are provided only as representative examples. Various modifications to the preferred embodiments will be readily apparent to one skilled in the art, and the general principles defined herein may be applied to other embodiments and applications without departing from the scope of the disclosure. The present disclosure is not intended to be limited to the embodiments shown, but is to be accorded the widest possible scope consistent with the principles and features disclosed herein.

Carbon dioxide emissions are recognized as a significant concern relating to cement production and the use of concrete as a building material. With modernization in construction-related methodologies and technologies, there has been a rapid shift from producing cement in large quantities to identifying innovative approaches that reduce the volume of the carbon emissions occurring during the various cement manufacturing processes.

The construction industry has been on the look-out for better, stronger, and more sustainable cement products, such as bio-cement tiles. Such bio-cement tiles require top-coat material that is able to be used as a sealant and grout as well. Accordingly, innovative approaches are sought that is able to be part of a top-coat material composition strategy. Such innovative approaches should aim at providing a chemical resistant and stain resistant top-coat material for sustainable environmental-friendly (e.g., substantially, or entirely free of cement) bio-concrete as a building material.

Further, innovative approaches should aim at providing synergistic effect on bio-cement tiles, such as, but not limited to, high durability, exemplary resistance to chemicals, stains, and water, and no requirement of UV-curing equipment. The embodiments of the present disclosure aim to provide an improved, new, top-coat material composition having several advantages, some of which are listed above.

Embodiments of the present solution provide new, improved, top-coat material compositions with many advantages. By leveraging such top-coat material compositions in building architectures, the present disclosure ensures highly durable, chemical resistant, stain resistant, and water-resistant top-coat material that eliminates or reduces shrinkage cracks and ensures low thermal conductivity.

Top-coat material compositions for bio-cement tiles in accordance with the embodiments are different from conventional top-coat compositions. This difference is based both on use as well as composition. In some embodiments, these top-coat material compositions are used for applying on the surface of bio-cement tiles with extended durability. The top-coat material compositions impart various properties, such as chemical resistance, stain resistance and water resistance to the surface of the bio-cement tiles. The top-coat material compositions include a specific form of acrylic resins and a plurality of solvents, such as xylene, naphtha, trimethylbenzene, and ethylbenzene. Such a coating of the top-coat material does not require UV-curing technology, thus excludes the requirement of UV-curing equipment making it economical for the end user. The top-coat material compositions further diminish the water absorption properties of the surface of the bio-cement tiles.

Some embodiments provide several other objects and advantages, some of which are discussed below. Such top-coat material compositions have rapid-setting properties. A further significant advantage provided by these top-coat material compositions is their low thermal conductivity. For example, top-coat material compositions coating bio-cement tiles installed in a house's interior wall do not allow significant heat transfer through them. Such coating improves thermal comfort inside the house by consuming less electricity. In addition, these top-coat material compositions are more durable than conventional concrete of the same grade when used on bio-cement tiles, do not shrink, have high thermal insulation, and have high fire-resistance, among other like benefits. Usage of these top-coat material compositions results in reduced insurance costs due to increased security, durability, and infallibility compared to structures manufactured with conventional top-coat compositions. These and other like advantages make the disclosed embodiments more environmentally friendly, economical, and sustainable.

Certain terms and phrases have been used throughout the disclosure and will have the following meanings in the context of the ongoing disclosure.

“Concrete” for the purposes of the present disclosure refers to a hard strong building material.

“Cement” for the purposes of the present disclosure refers to a binder, a substance that sets and hardens and is able to bind other materials together. Cement is manufactured through a closely controlled chemical combination of calcium, silicon, aluminum, iron, and other ingredients. Common materials used to manufacture cement are able to include, but are not limited to, limestone, shells, and chalk or marl combined with shale, clay, slate, blast furnace slag, silica sand, and iron ore. Some of the types of cement are able to include, but are not limited to, hydraulic and elite cements, such as Portland Cement, blended cement, masonry cement, oil well cement, natural cement, alumina cement, expansive cement, and the like, and mixtures thereof.

“Coating” for the purposes of the present disclosure refers to a curable composition that is deposited on s surface that serves to protect the surface.

“Bio-cement” for the purposes of the present disclosure refers to a calcareous material. Bacteria in such material is activated and then carbon and calcium are precipitated to produce a biologically forged calcium carbonate.

“Bio-cement tiles” for the purposes of the present disclosure refers to bio-based tiles for interior use in commercial, institutional, and residential building projects. Bio-cement tiles are able to be used in vertical facing assemblies and installed on a support wall with adhesive or mechanical systems or adhered onto a fixed substrate in horizontal conditions. Bio-cement tiles are manufactured from locally sourced aggregate and biologically generated calcium carbonate bio-cement material, resulting in modular units with one or more finished faces. Bio-cement tiles are formed by vibratory compaction in a semi-dry mix and cured in ambient temperatures, reaching full strength in less than three days.

In accordance with some embodiments, the present disclosure is directed to a top-coat material composition for bio-cement tiles for use in construction. The top-coat material composition is able to include acrylic resin, xylene, naphtha, trimethylbenzene, and ethylbenzene.

In some embodiments, the top-coat material composition is able to be available in prepacked/prepackaged form, where various components are blended for a predetermined amount of time until a workable and consistent mix is obtained. In some embodiments, the top-coat material composition of the present disclosure is highly suitable for forming one or more of: sealant, grout, or a top coating material on the surface of bio-cement tiles for protection against any form of chemical or stain. In some embodiments, the bio-cement tiles coated with the top-coat material composition are tested to determine resistance to various chemical substances, such as Ammonium chloride, Citric acid solution, Lactic acid, Sodium hypochlorite solution, Hydrochloric acid solution, Hydrochloric acid solution, Potassium hydroxide, and Potassium hydroxide, to name a few. Accordingly, the bio-cement tiles coated with the top-coat material composition confirm to ASTM C650 standard, though other standards are also contemplated. Further, the bio-cement tiles coated with the top-coat material composition are tested to determine resistance to various agents, such as grout, carbon lamp black, waterproof ink black, washable ink, potassium permanganate solution (1%), and methylene blue (1%), to name a few. Accordingly, the bio-cement tiles coated with the top-coat material composition confirm to ASTM C1378 standard, though other standards are also contemplated.

In some embodiments, the mix is air cured for a minimum curing period of 24 hours. A fully cured coating achieves maximum structural integrity (or hardness) and strength, is fully adhered to the surfaces of the bio-cement tiles and is stable enough for service. The exact time and temperature used to cure the coated surface depends on various factors, for example the size of the coated surface, the thickness of the coating, porosity of the surface, texture of the surface, and weather conditions. It will be appreciated if other periods are contemplated.

These and other embodiments are discussed in detail below.

In some embodiments, the present disclosure relates to a top-coat material composition that includes acrylic resin that is a copolymer composed of methacrylate, acrylate, and vinyl monomers. Such resins are able to be available in solution, dispersion, or solid form. The monomers are usually esters of acrylic, methacrylic acids or their derivatives, and are able to be functionalized by introducing different chemical groups. As compared with other synthetic polymer resin materials, acrylic resins exhibit light resistance, weather resistance, durability, and good acid and alkali corrosion resistance. A person of ordinary skill in the art will understand that other scenarios are also possible for the same.

In some embodiments, some top-coat material compositions in accordance with the embodiments include xylene because of the various advantages that it offers. For example, xylene is a powerful aromatic hydrocarbon solvent that aids in dissolving and dispersing the acrylic resin in the mixture. It has a strong odor. In some embodiments, the top-coat material composition includes xylene, where xylene is between 15-25% by weight of the top-coat material composition. A person of ordinary skill in the art will understand that other scenarios are also possible for the same.

In some embodiments, naptha is included as one of the components of the top-coat material composition. In some embodiments, the naptha is a flammable petroleum-based solvent or diluent. In addition to the functions mentioned above, the naptha contributes to proper application and film formation. The naptha has a milder odor. In some embodiments, the top-coat material composition includes naptha, where naptha is between 30-55% by weight of the top-coat material composition. A person of ordinary skill in the art will understand that other scenarios are also possible for the same.

Trimethylbenzene is another component of some embodiments of top-coat material compositions. Trimethylbenzene is an isomer mixture known as “Pseudocumene.” Trimethylbenzene enhances the overall performance of the sealer, such as, the top-coat material composition. In particular, one of the three isomers of trimethylbenzene, such as, 1,2,4-trimethylbenzene, is used in the top-coat material compositions. 1,2,4-trimethylbenzene is nearly insoluble in water but soluble in organic solvents. In some embodiments, the top-coat material composition includes trimethylbenzene, where trimethylbenzene is between 10-20% by weight of the top-coat material composition. A person of ordinary skill in the art will understand that other scenarios are also possible for the same.

Ethylbenzene is yet another component of some embodiments of top-coat material compositions. Ethylbenzene, as a solvent, dissolves and disperses acrylic resin, contributing to proper application on the surface of bio-cement tiles. In some embodiments, the top-coat material composition includes ethylbenzene, where ethylbenzene is between 5-10% by weight of the top-coat material composition.

In some embodiments, the top-coat material composition sets rapidly by an amount of time, during which the top-coat material composition loses its fluidity by a predetermined amount (e.g., it changes from a fluid state to a solid state). In some embodiments, the setting time of the top-coat material composition ranges between 8-24 hours.

Other properties of the present top-coat material composition are able to include, but are not limited to, improved fire resistance, low thermal conductivity, high early strength, fast setting time, reduction or elimination of shrinkage cracks, and other like properties.

Top-coat material compositions in accordance with some embodiments have many applications in architecture, such as in the formation of interior cladding of bio-cement tiles.

Further, the present top-coat material compositions are able to be made available in a prepackaged form, and predetermined amounts of solvents are added to acrylic resin in an amount such that predetermined range of flowable consistency is obtained. A person of ordinary skill in the art will understand that other configurations and scenarios are also possible for the compositions.

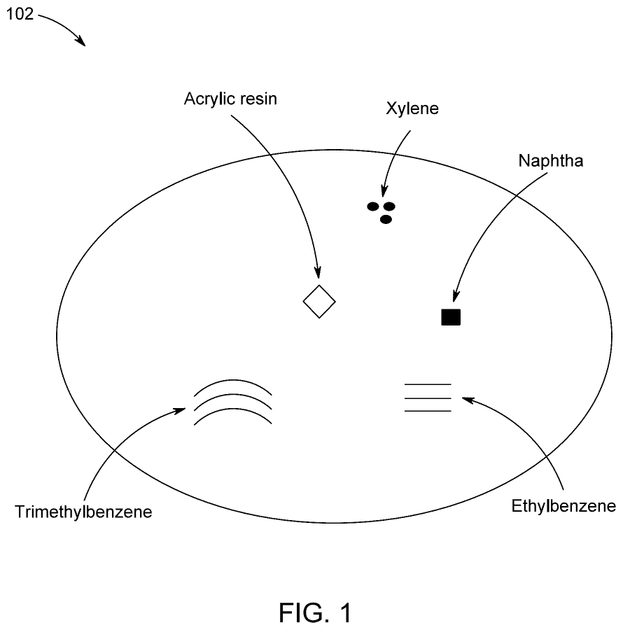

FIG. 1 illustrates ingredients collated in the form of a group 102 that make up an exemplary top-coat material composition, in accordance with some embodiments of the present disclosure. In some embodiments, the ingredients are able to include, but are not limited to, acrylic resin, xylene, naphtha, trimethylbenzene, and ethylbenzene. Thus, in some embodiments, the group 102 is able to be used to manufacture the exemplary top-coat material composition. The top-coat material composition is able to be referred to as a solvent-based composition as all the components, except for the acrylic resin, fall under the category of solvents. However, these components have distinctive characteristics and serve different purposes in the formulation, as described above.

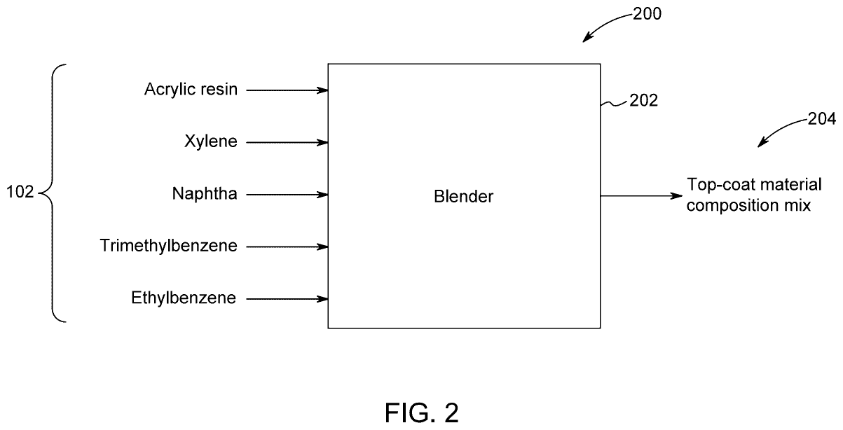

FIG. 2 illustrates an arrangement 200 for preparing top-coat material compositions, in accordance with some embodiments of the present disclosure.

The arrangement 200 includes a blender 202 that receives as inputs the ingredients 102 and produces a top-coat material composition mix 204, interchangeably referred to as top-coat material. The ingredients 102 include acrylic resin, xylene, naphtha, trimethylbenzene, and ethylbenzene. In some embodiments, all these components 102 are added in the blender 202 in appropriate quantities according to the desired top-coat material composition. The table below (Table 1) indicates the appropriate quantities of the components of the top-coat material composition in accordance with some embodiments. The quantities indicated in Table 1 are non-limiting. Other ingredients and quantities are contemplated.

TABLE 1

| Component | Quantity |
|---|---|
| Acrylic Resin | 20-30% by weight of the top-coat material composition |
| Xylene | 15-25% by weight of the top-coat material composition |
| Naphtha | 30-55% by weight of the top-coat material composition |
| Trimethylbenzene | 10-20% by weight of the top-coat material composition |
| Ethylbenzene | 5-10% by weight of the top-coat material composition |

A person of ordinary skill in the art will understand that a blender blends and mixes materials to produce a resulting mix. Not deviating from the scope of the disclosure, the blender 202 is able to include any type of industrial scale planetary mixer which is able to produce homogenous mixture. A person of ordinary skill in the art will understand that other configurations are also possible for the blender 202.

Referring to FIG. 2, once the components 102 are mixed in the blender 202 at a normal speed for a predetermined amount of time, a consistent and workable top-coat material composition mix 204 (with a predetermined range of flowable consistency) is obtained. This consistent and workable top-coat material composition 204 is able to be used for various purposes such as, but not limited to, sealing, and grouting of bio-cement tiles that are meant for interior use in commercial, institutional, and residential building projects, to name only a few examples. Those skilled in the art will recognize other methods and devices that are able to be used for determining chemical, water, and stain resistance values and ranges and established by Standards, such as the ASTM standards.

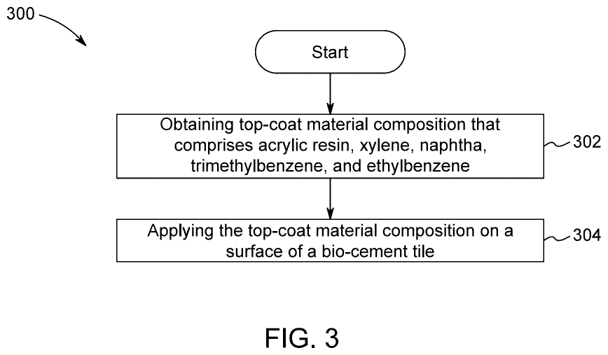

FIG. 3 illustrates a flowchart specifying the steps of a method 300 for using top-coat material compositions for construction activities, in accordance with some embodiments of the present disclosure. The top-coat material composition described herein is able to be equivalent to the top-coat material composition 204 of FIG. 2 in its functionality and characteristics, as described above.

Although specific operations are disclosed herein, such operations are examples and are non-limiting. In different embodiments, to name only a few examples, the method 300 includes other steps, the sequence of the steps is modified, some steps are omitted, or any combination of these variations may be incorporated. The steps of the method 300 are able to be automated or semi-automated. In various embodiments, one or more of the operations of the method 300 are able to be controlled or managed by software, by firmware, by hardware, or by any combination thereof, but is not limited to such.

In some embodiments, the method 300 includes processes in accordance with the present disclosure which are able to be controlled or managed by a processor(s) and electrical components under the control of a computer or computing device comprising computer-readable media containing non-transitory computer-executable instructions or code that when executed by the processor(s) perform the steps of the method 300. The readable and executable instructions (or code) are able to reside, for example, in data storage such as volatile memory, non-volatile memory, and/or mass data storage, as only some examples. In some embodiments, automation of the method 300 through a computer employs various peripherals such as sensors, robotic arms, and the like.

Referring to FIG. 3, at a step 302, the top-coat material composition, such as, the top-coat material composition mix 204, that comprises acrylic resin, xylene, naphtha, trimethylbenzene, and ethylbenzene, is obtained. Predetermined quantities of various components of the top-coat material composition, as defined in Table 1 above, are added in a blender (for example, blender 202 of FIG. 2) in factory settings. The predetermined quantities of various components are blended for a predetermined amount of time until a workable and consistent mix (for example, top-coat material composition mix 204 of FIG. 2) is obtained. In some embodiments, the predetermined amount of time for which the various components of the top-coat material composition are blended with each other is able to be based on various parameters. Examples of such parameters are able to include, but are not limited to, batch of the mixture, type of the blender 202, brand of the blender 202, and configuration of the blender 202 (such as rotations per minute (RPM)).

Next, at a step 304, the top-coat material composition, such as, the top-coat material composition mix 204, is applied on a surface of the bio-cement tiles that are meant for interior use in commercial, institutional, and residential building projects. The surface of the bio-cement tiles is able to correspond to, for example, a wall or a ceiling. Such surface should be prepared before applying the top-coat material composition mix 204 for best results. For example, the surface should be inspected to ensure that it is clean, smooth, dry, and free from any loose materials, grease, and oil. Next, a thin coat of the top-coat material composition mix 204 should be applied on to the surface using, for example, a solvent-resistant roller, hand-held pump sprayer, or a high-volume low-pressure sprayer.

Embodiments of the top-coat material composition and the methods of making and using them provide an environmental-friendly product. Conventional top-coat mixture compositions are not durable, and neither are they chemical resistant nor stain resistant. Conventional top-coat mixture compositions also require UV curing. However, top-coat material compositions in accordance with some embodiments do not require any kind of UV curing, and in some embodiments only air curing is performed. In some embodiments, the mixes include acrylic resin, xylene, naphtha, trimethylbenzene, and ethylbenzene. Furthermore, conventional top-coat compositions are less durable, thus require frequent coating, for example, after every two years. However, the top-coat material composition in accordance with some embodiments is highly durable, and offers substantial resistance towards various chemicals, stains, and even water. The top-coat material composition, after application on the surface, penetrates the concrete and fills all the voids inside the concrete to form a film coat over the surface. The depth of penetration and chemical resistance of this coat determine its durability, which is more than the conventional top-coat compositions, for example, more than 5 years.

In some embodiments, a system (in an example, a computer) for performing the steps of method 300 is automated. In some embodiments, the computer is able to comprise a memory storing computer-executable instructions that when executed by a processor(s) perform the steps of method 300.

The terms “comprising,” “including,” and “having,” as used in the specification herein, shall be considered as indicating an open group that may include other elements not specified. The terms “a,” “an,” and the singular forms of words shall be taken to include the plural form of the same words, such that the terms mean that one or more of something is provided. The term “one” or “single” may be used to indicate that one and only one of something is intended. Similarly, other specific integer values, such as “two,” may be used when a specific number of things is intended. The terms “preferably,” “preferred,” “prefer,” “optionally,” “may,” and similar terms are used to indicate that an item, condition, or step being referred to is an optional (not required) feature of the invention. The term “connecting” includes connecting, either directly or indirectly, and “coupling,” including through intermediate elements.

The disclosure has been described with reference to various specific and preferred embodiments and techniques. However, it should be understood that many variations and modifications may be made while remaining within the spirit and scope of the disclosure. It will be apparent to one of ordinary skill in the art that methods, devices, device elements, materials, procedures, and techniques other than those specifically described herein can be applied to the practice of the disclosure as broadly disclosed herein without resort to undue experimentation. All art-known functional equivalents of methods, devices, device elements, materials, procedures, and techniques described herein are intended to be encompassed by this disclosure. Whenever a range is disclosed, all subranges and individual values are intended to be encompassed. This invention is not to be limited by the embodiments disclosed, including any shown in the drawings or exemplified in the specification, which are given by way of example and not of limitation. Additionally, it should be understood that the various embodiments of the building blocks described herein contain optional features that can be individually or together applied to any other embodiment shown or contemplated here to be mixed and matched with the features of that building block.

While the disclosure has been described with respect to a limited number of embodiments, those skilled in the art, having benefit of this disclosure, will appreciate that other embodiments can be devised which do not depart from the spirit and scope of the disclosure as disclosed herein.

We claim:

1. A top-coat material composition for a bio-cement tile, comprising:
acrylic resin; and
a plurality of solvents that comprises xylene, naphtha, trimethylbenzene, and ethylbenzene,
wherein a top-coat material when applied on a surface of the bio-cement tile penetrates the surface and fills voids within the bio-cement tile to form a chemical, water, and stain resistant coat over the surface of the bio-cement tile.

2. The top-coat material composition of claim 1, wherein:
a quantity of the acrylic resin is between 20-30% by weight of the top-coat material composition;
a quantity of the xylene is between 15-25% by weight of the top-coat material composition;
a quantity of the naphtha is between 30-55% by weight of the top-coat material composition;
a quantity of the trimethylbenzene is between 10-20% by weight of the top-coat material composition; and
a quantity of the ethylbenzene is 5-10% by weight of the top-coat material composition.

3. The top-coat material composition of claim 1, wherein the top-coat material applied on the surface of the bio-cement tile reduces water permeability of the bio-cement tile.

4. The top-coat material composition of claim 1, wherein the top-coat material composition applied on the surface of the bio-cement tile is colorless.

5. The top-coat material composition of claim 1, wherein the top-coat material composition excludes a requirement of ultraviolet (UV)-curing.

6. A method of using top-coat material composition in a construction activity, the method comprising:
obtaining the top-coat material composition that comprises acrylic resin, xylene, naphtha, trimethylbenzene, and ethylbenzene; and
applying the top-coat material composition on a surface of a bio-cement tile,
wherein the top-coat material composition penetrates the surface and fills voids within the bio-cement tile to form a chemical, water, and stain resistant coat over the surface of the bio-cement tile.

7. The method of claim 6, wherein:
a quantity of the acrylic resin is between 20-30% by weight of the top-coat material composition;
a quantity of the xylene is between 15-25% by weight of the top-coat material composition;
a quantity of the naphtha is between 30-55% by weight of the top-coat material composition;
a quantity of the trimethylbenzene is between 10-20% by weight of the top-coat material composition; and
a quantity of the ethylbenzene is between 5-10% by weight of the top-coat material composition.

8. The method of claim 6, wherein the top-coat material composition applied on the surface of the bio-cement tile reduces water permeability of the bio-cement tile.

9. The method of claim 6, wherein the top-coat material composition applied on the surface of the bio-cement tile is colorless.

10. The method of claim 6, wherein the top-coat material composition excludes a requirement of ultraviolet (UV)-curing.
